(19) United States
(12) Patent Application Publication
(10) Pub. No.: US 2026/0333421 A1
(43) Pub. Date: Oct. 22, 2026

(54) COORDINATED NON PRIMARY CHANNEL ACCESS (NPCA) OPERATION

(71) Applicant: MaxLinear, Inc., Carlsbad, CA (US)

(72) Inventors: Iñaki Val Beitia, Vitoria (ES); Oren Kedem, Modii'n-Maccabim-Reut (IL); Sigurd Schelstraete, Menlo Park, CA (US); Marcos Martínez Vázquez, Barcelona (ES)

(73) Assignee: MaxLinear, Inc., Carlsbad, CA (US)

(21) Appl. No.: 19/651,544

(22) Filed: Apr. 17, 2026

Related U.S. Application Data
(60) Provisional application No. 63/791,310, filed on Apr. 18, 2025.

(51) Int. Cl. H04W 74/08; H04W 28/02

(52) U.S. Cl. CPC H04W 74/08; H04W 28/0278

(57) ABSTRACT

An access point (AP) may include a processing device. The processing device may switch, at the AP, from a primary channel to a non-primary channel access (NPCA) primary channel. The AP may identify, at the AP, one or more stations (STAs) on the NPCA primary channel. The AP may send, from the AP to the one or more STAs on the NPCA primary channel, one or more downlink frames using the NPCA primary channel.

### RELATED APPLICATION

This application claims the benefit of U.S. Provisional Application No. 63/791,310, filed Apr. 18, 2025, the disclosure of which is incorporated herein by reference in its entirety.

### FIELD

The examples discussed in the present disclosure are related to coordinated non primary channel access (NPCA) operation.

### BACKGROUND

Unless otherwise indicated herein, the materials described herein are not prior art to the claims in the present application and are not admitted to be prior art by inclusion in this section.

An access point (AP), is a networking hardware device that allows other Wi-Fi® devices to connect to a wired network. As a standalone device, the AP may have a wired connection to a router, but, in a wireless router, it can also be an integral component of the router itself. There are many wireless data standards that have been introduced for wireless access point and wireless router technology such as Institute of Electrical and Electronics Engineers (IEEE) 802.11a, IEEE 802.11b, IEEE 802.11g, IEEE 802.11n (Wi-Fi® 4), IEEE 802.11ac (Wi-Fi® 5), IEEE 802.11ax (Wi-Fi® 6), IEEE 802.11be (Wi-Fi® 7), and so forth.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, an access point (AP) may include a processing device. The processing device may switch, at the AP, from a primary channel to a non-primary channel access (NPCA) primary channel. The AP may identify, at the AP, one or more stations (STAs) on the NPCA primary channel. The AP may send, from the AP to the one or more STAs on the NPCA primary channel, one or more downlink frames using the NPCA primary channel.

In some examples, a STA may include a processing device. The processing device may receive, at the STA from an AP, an initial control frame on a NPCA primary channel. The processing device may send, from the STA to the AP, one or more frames on the NPCA primary channel. The processing device may receive, at the STA from the AP, one or more downlink frames on the NPCA primary channel.

In some examples, a method may include: switching, at the AP, from a primary channel to a NPCA primary channel; identifying, at the AP, one or more STAs on the NPCA primary channel; and sending, from the AP to the one or more STAs on the NPCA primary channel, one or more downlink frames using the NPCA primary channel.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example non primary channel access (NPCA) mechanism.

FIG. 2 illustrates an example NPCA scenario.

FIG. 3 illustrates an example NPCA scenario with hidden nodes.

FIG. 4 illustrates an example process flow of NPCA.

FIG. 5 illustrates an example process flow of NPCA.

FIG. 6 illustrates a block diagram of an example system operable to perform NPCA.

FIG. 7 illustrates a diagrammatic representation of a machine in the example form of a computing device within which a set of instructions, for causing the machine to perform any one or more of the methods discussed herein, may be executed.

FIG. 8 illustrates example NPCA performance results.

FIG. 9A illustrates example NPCA performance results under hidden nodes.

FIG. 9B illustrates example NPCA performance results under hidden nodes.

FIG. 10A illustrates example NPCA performance results under hidden nodes.

FIG. 10B illustrates example NPCA performance results under hidden nodes.

FIG. 11 illustrates example NPCA performance results under hidden nodes.

FIG. 12 illustrates example NPCA performance results under hidden nodes using buffer status report polling (BSRP) as initial control frame.

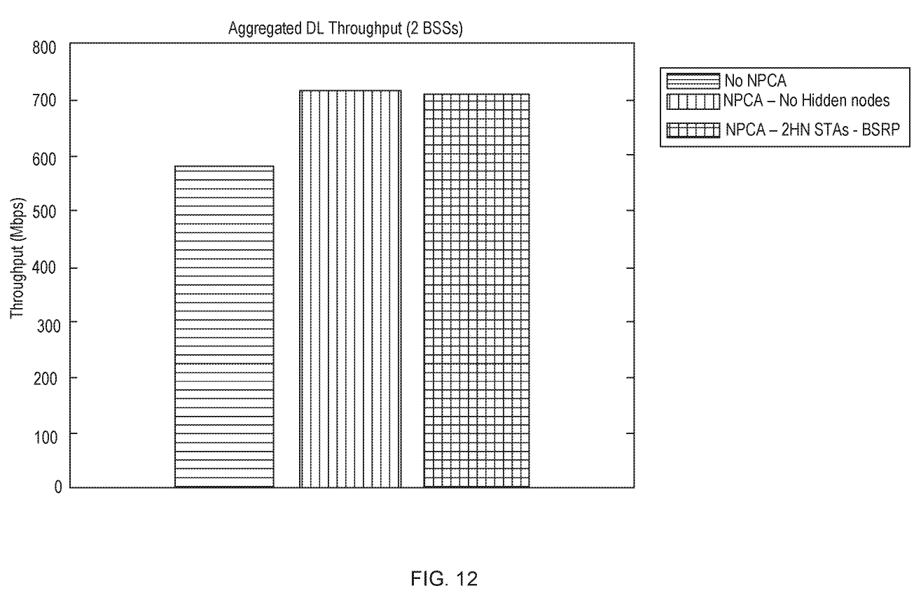

### DESCRIPTION

Non Primary Channel Access (NPCA) feature has been approved under the new IEEE 802.11bn amendment. This feature allows a basic service set (BSS) (composed of non-AP and AP STAs) to determine the time occupancy of an ongoing overlapping BSS (OBSS) transmission, and in case of having available spectrum in a non-primary channel, the STAs may move to that channel and initiate data transfer. The STAs may return to the primary channel before the OBSS finishes its operation and frees the primary channel.

Examples of the present disclosure will be explained with reference to the accompanying drawings.

Under ideal conditions, the NPCA feature may show performance gain, because the spectrum utilization efficiency may be enhanced by taking advantage of the non-utilized spectrum from the OBSS.

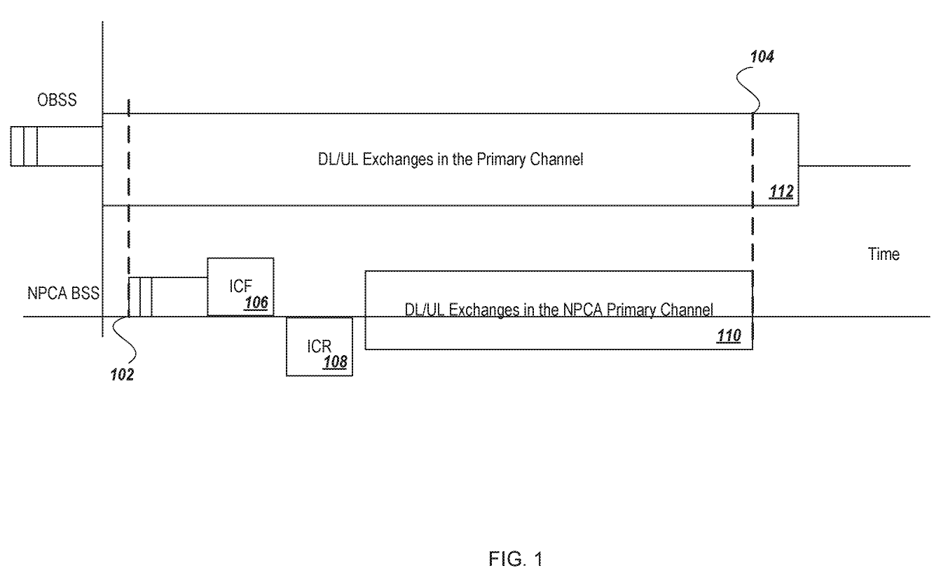

FIG. 1 illustrates that the BSS of interest detects the OBSS activity, as shown at 102, identifies the OBSS transmission length, and determines if NPCA can be triggered. After detecting the OBSS activity, the BSS of interest may move to the NPCA BSS. An initial control frame 106 may be transmitted on the NPCA BSS. An initial control response 108 may be provided in response. Downlink and uplink exchanges 110 may occur in the NPCA primary channel. Downlink and uplink exchanges 112 may occur in the primary channel when downlink and uplink exchanges are occurring in the NPCA primary channel. Proper BSS operation of NPCA may rely on: (1) joint operation for changing to the non-primary channel, and (2) joint operation for returning to the primary channel, before the OBSS ends, as shown at 104. Fairness may be provided when re-accessing the primary channel.

Modifications, additions, or omissions may be made to the components of FIG. 1 without departing from the scope of the present disclosure.

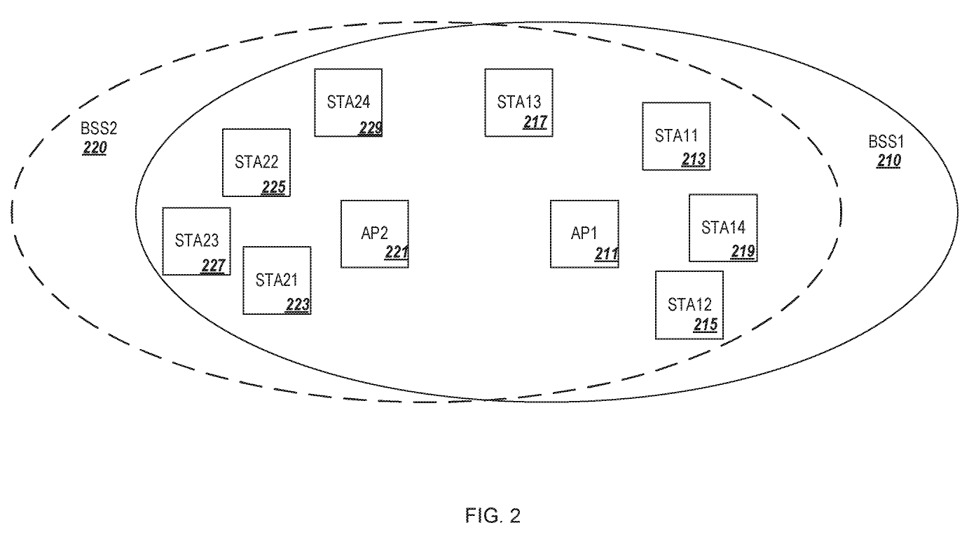

As illustrated in FIG. 2, two BSSs that may be NPCA capable (e.g., BSS1 210 and BSS2 220) may share the same primary channel. The BSSs may be composed of one AP and four non-AP STAs. BSS 1 210 may include AP 1 211, STA 11 213, STA 12 215, STA 13 217, and STA 14 219. BSS 2 220 may include AP 2 221, STA 21 223, STA 22 225, STA 23 227, and STA 24 229. The STAs 213, 215, 217, 219, 223, 225, 227, 229 may be in range; therefore the STAs 213, 215, 217, 219, 223, 225, 227, 229 may see each other. The APs 211, 221 may generate downlink traffic at a rate of e.g., 150 Mbps per STA. The APs 211, 221 may have the same bandwidth of 160 megahertz (MHz), while the STAs 213, 215, 217, 219, 223, 225, 227, 229 may have mixed operational bandwidth. Half of the STAs may have 80 MHz of bandwidth, while the rest of the STAs may have 160 MHz of bandwidth. When data is transmitted to a STA of 80 MHz, there may be a gap of 80 MHz that may be used by the other BSS through NPCA.

Modifications, additions, or omissions may be made to the components of FIG. 2 without departing from the scope of the present disclosure.

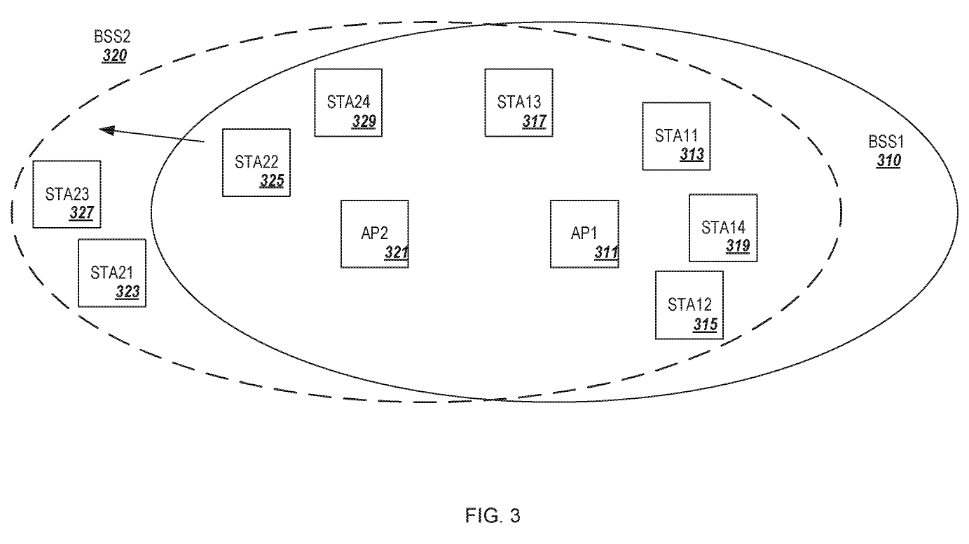

As illustrated in FIG. 3, a BSS1 310 may include AP 1 311, STA 11 313, STA 12 315, STA 13 317, and STA 14 319. BSS 2 320 may include AP 2 321, STA 21 323, STA 22 325, STA 23 317, and STA 24 329. From the previously deployed setup, nodes (e.g., STA 23 327 and STA21 323) may be moved and converted into hidden nodes. Partial performance decrease may be due to the fact that the AP may not know which associated (NPCA capable) STAs have changed to their NPCA Primary Channel. That is, channel coordination within the BSS may be lost.

Once an AP moves to the NPCA primary channel, the AP needs to know which STAs moved to the same channel. Usually, the AP may use a multi-user request to send (MU RTS) frame as an initial control frame for starting the transmission opportunity (TXOP). But the STAs may respond with the same clear to send (CTS) frame, making it difficult to identify the STAs that responded to the AP.

In an example, an AP may include a processing device. The processing device may switch, at the AP, from a primary channel to a NPCA primary channel. The processing device may identify, at the AP, one or more STAs on the NPCA primary channel. The processing device may send, from the AP to the one or more STAs on the NPCA primary channel, one or more downlink frames using the NPCA primary channel.

Alternatively or in addition, the processing device may send, from the AP to one or more STAs, a multi-user buffer status report polling (MU BSRP) trigger frame. The processing device may receive, at the AP from the one or more STAs, one or more frames. The processing device may send, from the AP to the one or more STAs, one or more downlink frames in response to receiving the one or more frames.

That is, the AP may send a BSRP trigger frame defined in the IEEE 802.11ax amendment. This frame may be intended to interrogate the STAs about the STAs buffer status for uplink traffic, while the purpose for this case may be different. The STAs may respond in the assigned resource unit and thus transmit different frames. Therefore the AP may know which STAs responded, and the AP may serve the correct STAs (the ones that moved to the NPCA primary channel), for instance, sending them downlink frames.

The processing device may switch, at the AP, to an NPCA primary channel. The processing device may identify, at the AP, one or more STAs using an NPCA primary channel based on the one or more frames. The MU BSRP trigger frame may be an initial control frame. The one or more STAs may include STAs that have different bandwidth capabilities (e.g., BW, BW/2, or the like).

That is, the AP may use the BSRP frame as the initial control frame after switching to the NPCA primary channel, instead of using the MU RTS frame. This allows the AP to know which non-AP STAs moved to the NPCA primary channel as well and may optimize the AP scheduler with the obtained information.

The performance may be enhanced. In one example, throughput may be increased by at least 20% when compared to a baseline in which NPCA is not used. In another example, one or more hidden nodes may reduce NPCA performance gain when compared to a baseline in which the MU BSRP trigger frame is not used. It can be seen how the use of BSRP to enquire the STAs allows the AP to schedule the downlink transfers in a more efficient way, which may remove the degradation due to the hidden nodes.

The STAs may use NPCA. The STA may include a processing device. The processing device may receive, at the STA from an AP, an initial control frame on a NPCA primary channel. The processing device may send, from the STA to the AP, one or more frames on the NPCA primary channel. The processing device may receive, at the STA from the AP, one or more downlink frames on the NPCA primary channel.

Alternatively or in addition, the processing device may receive, at the STA from an AP, a MU BSRP trigger frame on an NPCA primary channel. The processing device may send, from the STA to the AP, a frame. The processing device may receive, at the STA from the AP, a downlink frame.

The processing device may switch, at the STA, to a NPCA primary channel. The trigger frame may be an initial control frame. The STA may have different bandwidth capabilities (e.g., BW, BW/2, or the like). The performance may be enhanced. For example, the throughput may be increased by at least 20% when compared to a baseline in which NPCA is not used. The one or more hidden nodes may reduce NPCA performance gain when compared to a baseline in which the MU BSRP trigger frame is not used.

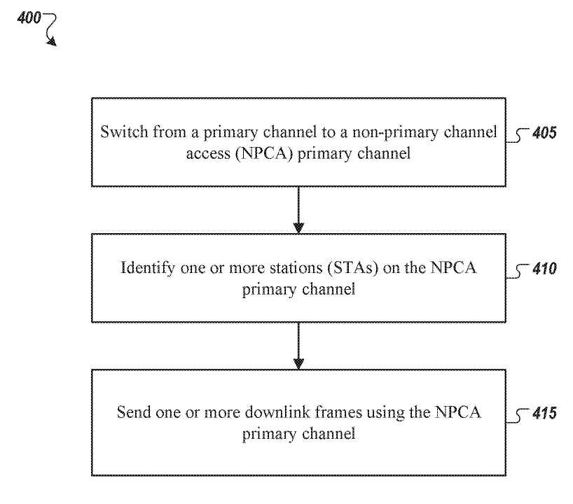

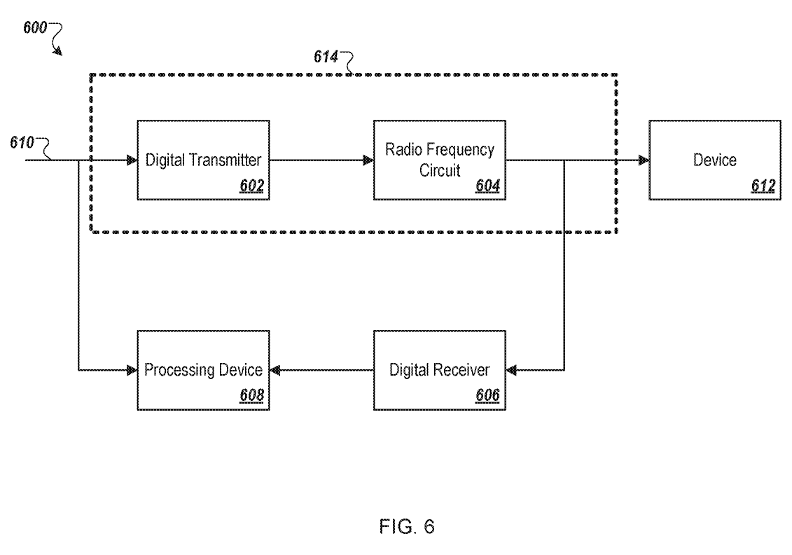

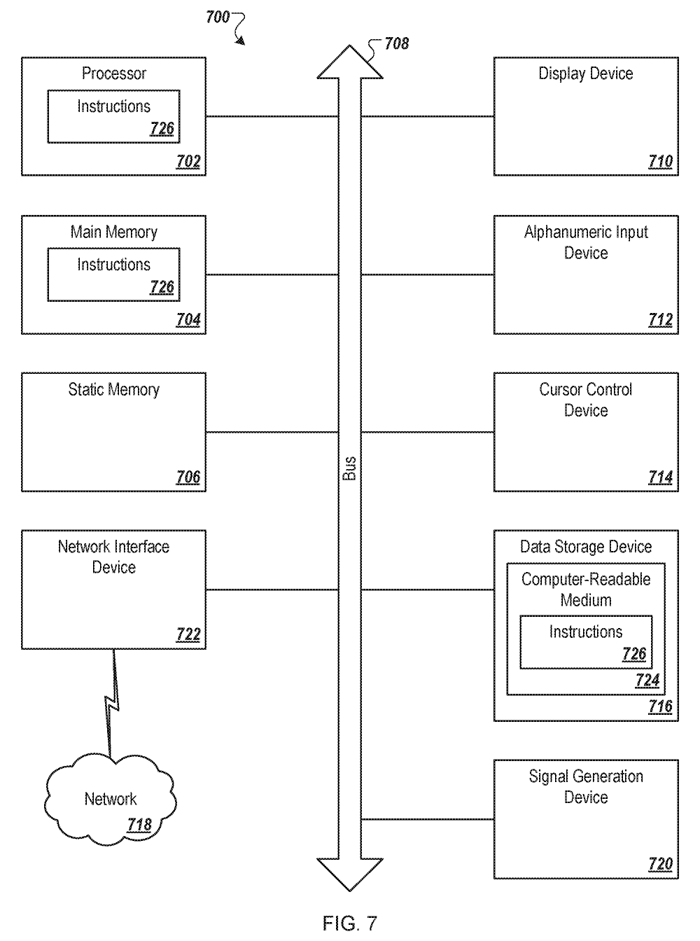

FIG. 4 illustrates a process flow of an example method 400 of coordinated NPCA, in accordance with at least one example described in the present disclosure. The method 400 may be arranged in accordance with at least one example described in the present disclosure. The method 400 may be performed by processing logic that may include hardware (circuitry, dedicated logic, etc.), software (such as is run on a computer system or a dedicated machine), or a combination of both, which processing logic may be included in the processing device 702 of FIG. 7, the communication system 600 of FIG. 6, or another device, combination of devices, or systems.

The method 400 may begin at block 405 where the processing logic may switch, at the AP, from a primary channel to a NPCA primary channel.

At block 410, the processing logic may identify, at the AP, one or more STAs on the NPCA primary channel.

At block 415, the processing logic may send, from the AP to the one or more STAs on the NPCA primary channel, one or more downlink frames using the NPCA primary channel.

The processing logic may send, from the AP to the one or more STAs, an initial control frame. The initial control frame may be a MU BSRP trigger frame. The processing logic may identify, at the AP, the one or more STAs on the NPCA primary channel based on one or more frames sent from the one or more STAs in response to the initial control frame. The one or more frames may be sent in assigned resource units. The one or more STAs may include STAs that have different bandwidth capabilities (e.g., BW, BW/2, or the like). The processing logic may switch, at the AP, from the NPCA primary channel to the primary channel when transmission on the NPCA primary channel is completed.

Modifications, additions, or omissions may be made to the method 400 without departing from the scope of the present disclosure. For example, in some examples, the method 400 may include any number of other components that may not be explicitly illustrated or described.

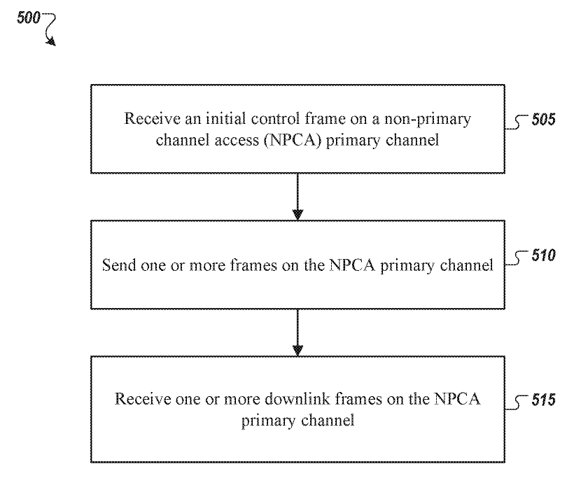

FIG. 5 illustrates a process flow of an example method 500 of coordinated NPCA, in accordance with at least one example described in the present disclosure. The method 500 may be arranged in accordance with at least one example described in the present disclosure.

The method 500 may be performed by processing logic that may include hardware (circuitry, dedicated logic, etc.), software (such as is run on a computer system or a dedicated machine), or a combination of both, which processing logic may be included in the processing device 702 of FIG. 7, the communication system 600 of FIG. 6, or another device, combination of devices, or systems.

The method 500 may begin at block 505 where the processing logic may receive, at the STA from an AP, an initial control frame on a NPCA primary channel.

At block 510, the processing logic may send, from the STA to the AP, one or more frames on the NPCA primary channel.

At block 515, the processing logic may receive, at the STA from the AP, one or more downlink frames on the NPCA primary channel.

The processing logic may switch, at the STA, to the NPCA primary channel. The initial control frame may be a MU BSRP trigger frame. The STAs may have different bandwidth capabilities (e.g., BW, BW/2, or the like). The one or more frames may be sent in assigned resource units. The processing logic may switch, at the STA, from the NPCA primary channel to the primary channel when transmission on the NPCA primary channel is completed.

Modifications, additions, or omissions may be made to the method 500 without departing from the scope of the present disclosure. For example, in some examples, the method 500 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 6 illustrates a block diagram of an example communication system 600 of coordinated NPCA, in accordance with at least one example described in the present disclosure. The communication system 600 may include a digital transmitter 602, a radio frequency circuit 604, a device 612, a digital receiver 606, and a processing device 608. The digital transmitter 602 and the processing device 608 may receive a baseband signal via connection 610. A transceiver 614 may comprise the digital transmitter 602 and the radio frequency circuit 604.

In some examples, the communication system 600 may include a system of devices that may communicate with one another via a wired or wireline connection. For example, a wired connection in the communication system 600 may include one or more Ethernet cables, one or more fiber-optic cables, and/or other similar wired communication mediums. Alternatively, or additionally, the communication system 600 may include a system of devices that may communicate via one or more wireless connections. For example, the communication system 600 may include one or more devices that may transmit and/or receive radio waves, microwaves, ultrasonic waves, optical waves, electromagnetic induction, and/or similar wireless communications. Alternatively, or additionally, the communication system 600 may include combinations of wireless and/or wired connections. In these and other examples, the communication system 600 may include one or more devices that may obtain a baseband signal, perform one or more operations to the baseband signal to generate a modified baseband signal, and transmit the modified baseband signal, such as to one or more loads.

In some examples, the communication system 600 may include one or more communication channels that may communicatively couple systems and/or devices included in the communication system 600. For example, the transceiver 614 may be communicatively coupled to the device 612.

In some examples, the transceiver 614 may obtain a baseband signal. For example, as described herein, the transceiver 614 may generate a baseband signal and/or receive a baseband signal from another device. In some examples, the transceiver 614 may transmit the baseband signal. For example, upon obtaining the baseband signal, the transceiver 614 may transmit the baseband signal to a separate device, such as the device 612. Alternatively, or additionally, the transceiver 614 may modify, condition, and/or transform the baseband signal in advance of transmitting the baseband signal. For example, the transceiver 614 may include a quadrature up-converter and/or a digital to analog converter (DAC) that may modify the baseband signal. Alternatively, or additionally, the transceiver 614 may include a direct radio frequency (RF) sampling converter that may modify the baseband signal.

In some examples, the digital transmitter 602 may obtain a baseband signal via connection 610. In some examples, the digital transmitter 602 may up-convert the baseband signal. For example, the digital transmitter 602 may include a quadrature up-converter to apply to the baseband signal. In some examples, the digital transmitter 602 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 602.

In some examples, the transceiver 614 may include one or more subcomponents that may be used in preparing the baseband signal and/or transmitting the baseband signal. For example, the transceiver 614 may include an RF front end (e.g., in a wireless environment) which may include a power amplifier (PA), a digital transmitter (e.g., 602), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, or the like. In some examples, a radio (e.g., a radio frequency circuit 604) of the transceiver 614 may be synchronized with the resource controller via the S-plane device, which may contribute to high-accuracy timing with respect to a reference clock.

In some examples, the transceiver 614 may obtain the baseband signal for transmission. For example, the transceiver 614 may receive the baseband signal from a separate device, such as a signal generator. For example, the baseband signal may come from a transducer that may convert a variable into an electrical signal, such as an audio signal output of a microphone picking up a speaker's voice. Alternatively, or additionally, the transceiver 614 may generate a baseband signal for transmission. In these and other examples, the transceiver 614 may transmit the baseband signal to another device, such as the device 612.

In some examples, the device 612 may receive a transmission from the transceiver 614. For example, the transceiver 614 may transmit a baseband signal to the device 612.

In some examples, the radio frequency circuit 604 may transmit the digital signal received from the digital transmitter 602. In some examples, the radio frequency circuit 604 may transmit the digital signal to the device 612 and/or the digital receiver 606. In some examples, the digital receiver 606 may receive a digital signal from the RF circuit and/or send a digital signal to the processing device 608.

In some examples, the processing device 608 may be a standalone device or system, as illustrated. Alternatively, or additionally, the processing device 608 may be a component of another device and/or system. For example, in some examples, the processing device 608 may be included in the transceiver 614. In instances in which the processing device 608 is a standalone device or system, the processing device 608 may communicate with additional devices and/or systems remote from the processing device 608, such as the transceiver 614 and/or the device 612. For example, the processing device 608 may send and/or receive transmissions from the transceiver 614 and/or the device 612. In some examples, the processing device 608 may be combined with other elements of the communication system 600.

FIG. 7 illustrates a diagrammatic representation of a machine in the example form of a computing device 700 within which a set of instructions, for causing the machine to perform any one or more of the methods discussed herein, may be executed. The computing device 700 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 700 includes a processing device (e.g., a processor) 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)) and a data storage device 716, which communicate with each other via a bus 708.

Processing device 702 represents one or more general-purpose processing devices such as a microprocessor, central processing unit, or the like. More particularly, the processing device 702 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also include one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein.

The computing device 700 may further include a network interface device 722 which may communicate with a network 718. The computing device 700 also may include a display device 710 (e.g., a liquid crystal display (LCD) or a cathode ray tube (CRT)), an alphanumeric input device 712 (e.g., a keyboard), a cursor control device 714 (e.g., a mouse) and a signal generation device 720 (e.g., a speaker). In at least one example, the display device 710, the alphanumeric input device 712, and the cursor control device 714 may be combined into a single component or device (e.g., an LCD touch screen).

The data storage device 716 may include a computer-readable storage medium 724 on which is stored one or more sets of instructions 726 embodying any one or more of the methods or functions described herein. The instructions 726 may also reside, completely or at least partially, within the main memory 704 and/or within the processing device 702 during execution thereof by the computing device 700, the main memory 704 and the processing device 702 also constituting computer-readable media. The instructions may further be transmitted or received over a network 718 via the network interface device 722.

While the computer-readable storage medium 724 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media, and magnetic media.

### EXAMPLES

The following provide examples of the performance characteristics according to the present disclosure.

### EXAMPLE 1: _Simulation Assumptions

There are various simulation assumptions including: (1) the simulation considers downlink (DL) traffic, (2) the AP initiates a TXOP using RTS/CTS frames, to protect the channel, (3) NPCA is activated by listening to the RTS/CTS sequence, (4) the TXOP is limited to one physical layer protocol data unit (PPDU) to avoid premature termination of the TXOP, (5) the involved OBSSs are NPCA capable, (6) the APs have the same bandwidth (BW), (7) the STAs have different bandwidths (BW and BW/2), to allow the activation of NPCA in the OBSS, (8) there is no switching delay for changing the channel, and (9) enhanced distributed channel access (EDCA) parameters are based on 802.11REVme (Table 9-194) for primary and non-primary channel access.

### EXAMPLE 2: _Simulation Setup – 2 BSS

Simulations covered OBSS scenarios under different deployment circumstances, focused on hidden node situations. Two independent NPCA BSSs, in the same primary channel, were composed of one AP and 4 non-AP STAs. The data traffic was per non-AP STA for the BSSs. The user datagram protocol (UDP) DL rate was 150 Mbps. Half of the STAs were BW/2 capable (the advantage to activate NPCA). Gradually, as shown in FIG. 3, the BSS2 STAs start becoming “Hidden nodes.” The BSS2 AP may also become a Hidden node.

### EXAMPLE 3: Simulation Results - NPCA

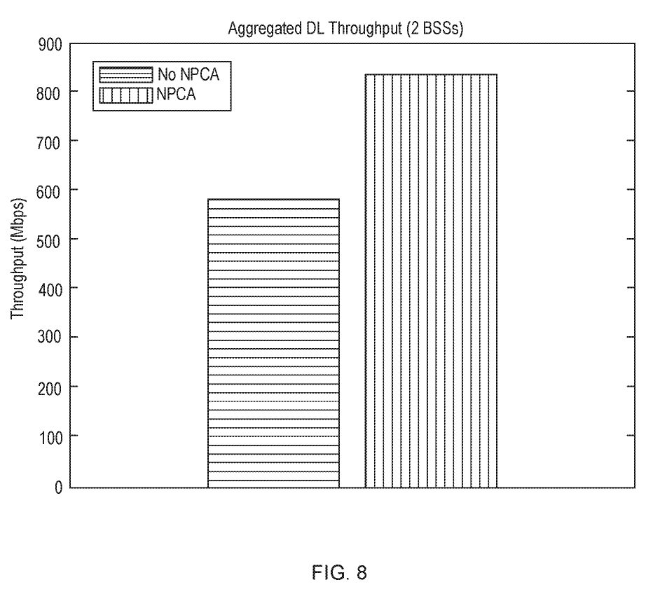

FIG. 8 showed the performance result of a simulation, comparing the overall throughput (for the BSSs) after switching on the NPCA feature.

The results showed an improvement in the performance of around 45%. Under these conditions, deployment did not consider hidden nodes. A hidden node does not detect all the activity from the OBSS, as it may see it partially. Therefore, it may occur that the conditions to move to the NPCA primary channel are not met, and it remains in the primary channel. Meanwhile, the AP may have moved to the NPCA primary channel, having a problem of coordination between the BSS nodes.

### EXAMPLE 4: NPCA Simulation Results – 2 BSSs

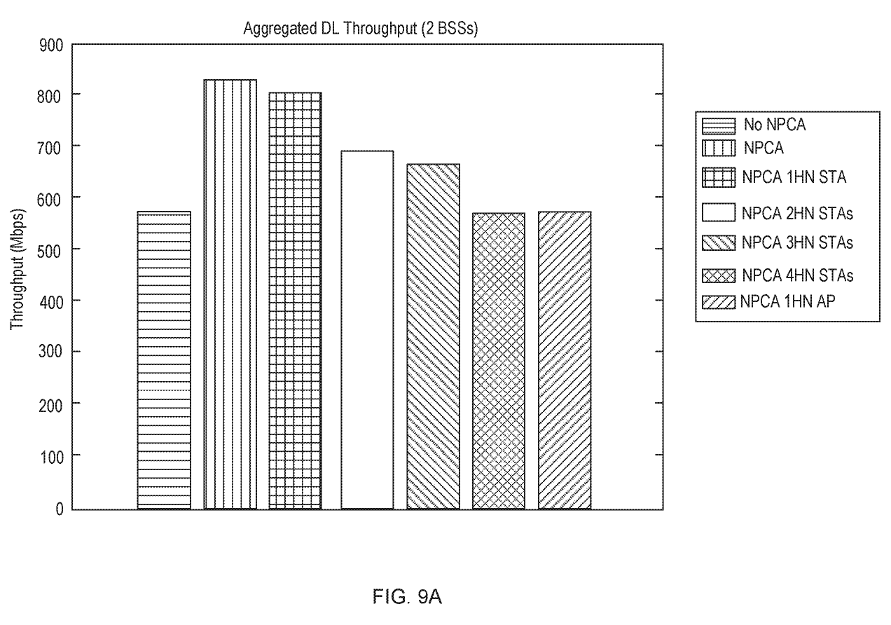

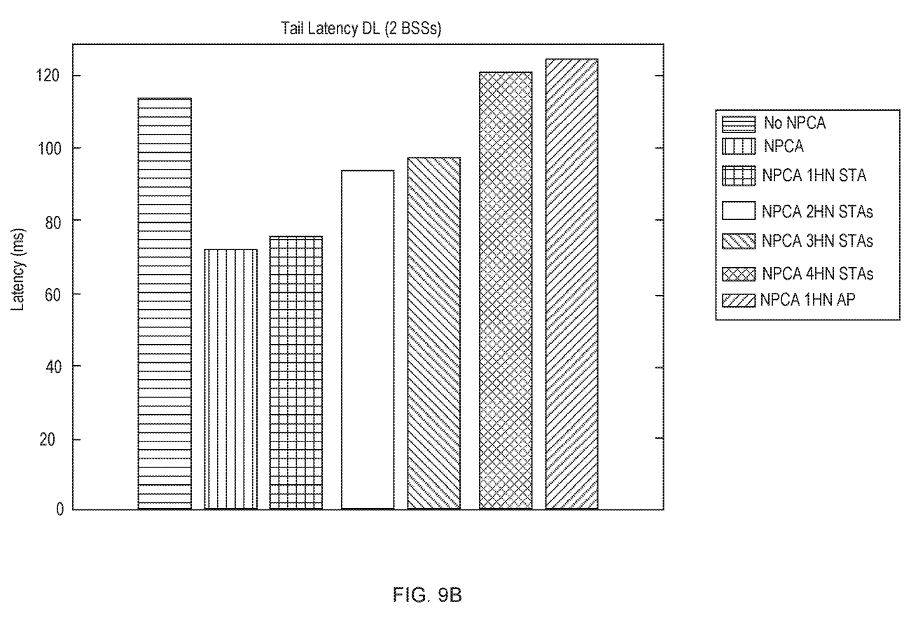

The STAs from one BSS were converted sequentially into hidden nodes, and FIGS. 9A and 9B show the performance results for these use cases (from no hidden nodes to all the STAs were hidden nodes).

The results in FIGS. 9A and 9B show how the performance decreased with the increment of hidden nodes, reaching the lower limit, which corresponded to disabling NPCA. When all the STAs were hidden nodes, the AP moved to the NPCA primary channel, resulting in NPCA not working at all, equal to being disabled. The same occurred when the AP was a hidden node.

The performance loss was larger when the affected STA is 80 MHz capable, as NPCA from the other BSS used this opportunity to gain the NPCA primary channel. When the STA is 160 MHz capable, there was a performance loss due to the fact that the AP does not know which STAs did not change to the NPCA primary channel. Therefore, the AP sent data to one STA that did not move to the NPCA primary channel, having a worse efficiency of the spectral resources.

The NPCA feature enabled a 45% of improvement in the aggregated throughput, under ideal circumstances (no hidden nodes).

At each step adding a hidden node in BSS2, the overall performance decreased. The performance loss was larger when the affected STA was BW/2 capable. When the STA was BW capable, there was a performance loss due to the fact that the AP did not know which STAs did not change to the NPCA primary channel. Once all the BSS2 STAs or the AP were hidden, the performance dropped to the lower limit (e.g., no NPCA). There was a waste of energy for those STAs that changed the channel when the AP did not change.

### EXAMPLE 5: _Simulation Setup – 3 BSS

The same setup as the 2 BSS scenario was proposed, but having 3 BSSs in the same channel. The STAs were in the energy detect (ED) or preamble detect (PD) range (no hidden nodes). Like in the previous scenario, the BSS3 STAs and AP were gradually replaced by hidden nodes.

### EXAMPLE 6: _Simulation Results – 3 BSS

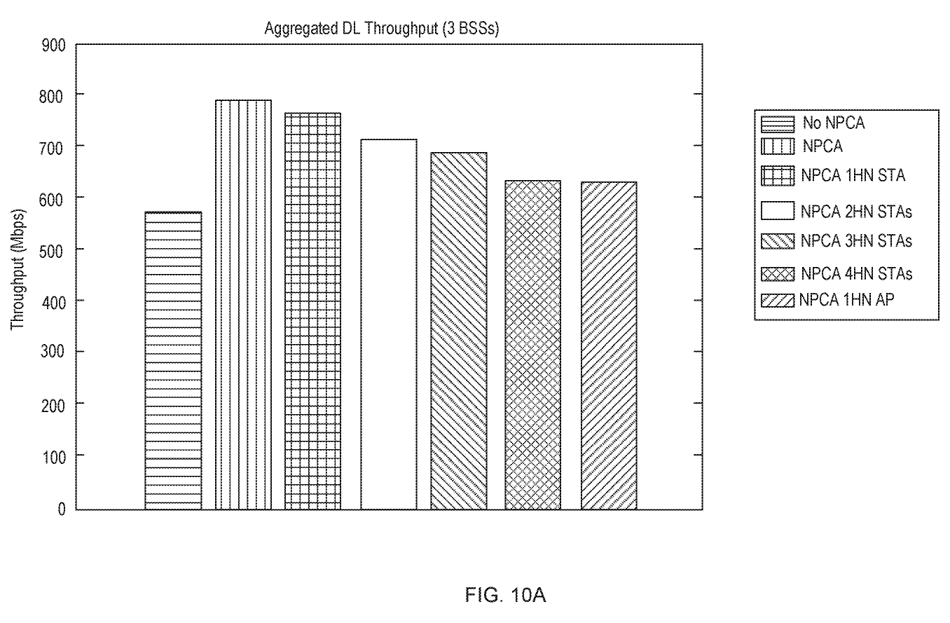

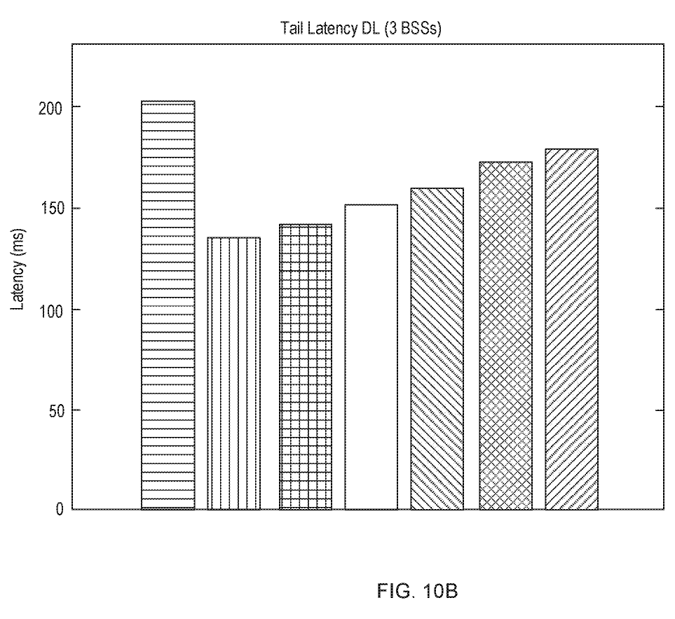

As shown in FIGS. 10A and 10B, the NPCA feature enabled a 39% improvement in the aggregated throughput, under ideal circumstances (no hidden nodes). At each step, when adding a hidden node in BSS3, the overall performance decreased. The performance loss was larger when the affected STA was BW/2 capable. When the STA was BW capable, there was a performance loss due to the fact that the AP did not know which STAs did not change to the NPCA primary channel.

Once all the BSS3 STAs were hidden, there was still a performance gain, because BSS1 and BSS2 may still perform NPCA with each other, but it was less effective as BSS3 AP still tries to get the NPCA Primary channel.

### EXAMPLE 7: _Simulation Setup – 2 BSS with OBSS not NPCA Capable

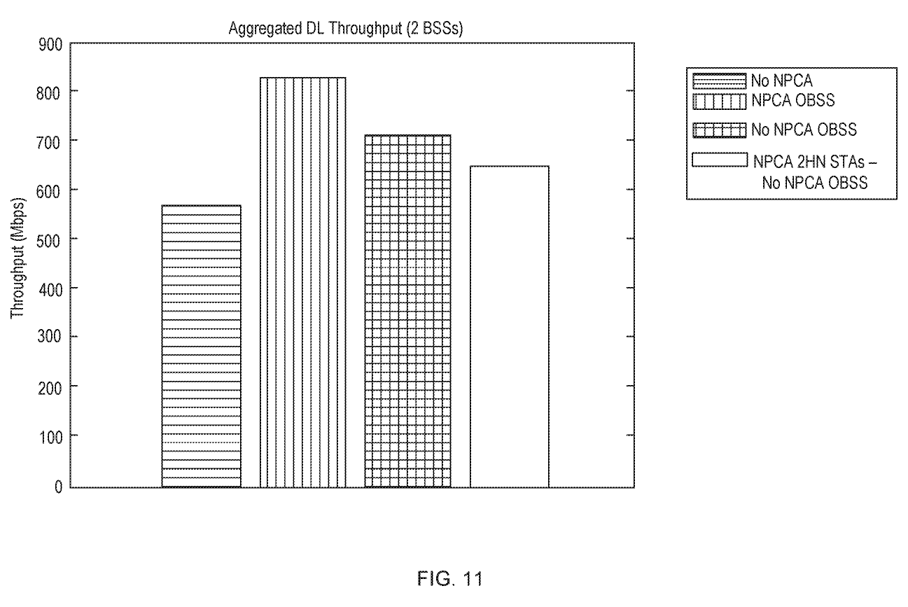

Previous setups assumed the OBSS was NPCA capable, but considering more “realistic” deployments. OBSS was not NPCA capable and 50% of the STAs are hidden nodes. As shown in FIG. 11, the performance gain was decreased. Compared to the baseline, the performance gain was reduced to 13%.

### Example 8: Coordinated NPCA Operation

Partial performance decreased due to the fact that the AP does not know which associated (NPCA capable) STAs have changed to their NPCA Primary Channel. Channel coordination within the BSS was lost. After the AP changed to NPCA Primary Channel and the AP won the contention, the AP transmitted a MU BSRP frame to inquire about its STAs, receiving responses from those STAs that changed the channel. The channel coordination was recovered. The use of BSRP as initial control frame (ICF) (after NPCA activation) attenuated the performance reduction in hidden node scenarios. Assuming OBSS was not NPCA capable and 50% of the STAs are hidden nodes. Compared to the baseline, the performance gain was increased to 24%.

### Example 9: NPCA Simulation Results – Summary

NPCA should consider deployment limitations such as hidden nodes, remembering that the performance gain will depend on the number of NPCA STAs deployed. The introduction of hidden nodes under different scenarios, as expected, showed a reduction in the NPCA performance gain. The use of a mechanism that allowed the AP to know in advance which STAs may have changed the primary channel, increased the efficiency, and therefore the overall performance.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. An access point (AP), comprising:
a processing device operable to:
switch, at the AP, from a primary channel to a non-primary channel access (NPCA) primary channel;
identify, at the AP, one or more stations (STAs) on the NPCA primary channel; and
send, from the AP to the one or more STAs on the NPCA primary channel, one or more downlink frames using the NPCA primary channel.

2. The AP of claim 1, wherein the processing device is operable to send, from the AP to the one or more STAs, an initial control frame.

3. The AP of claim 2, wherein the initial control frame is a multi-user buffer status report polling (MU BSRP) trigger frame.

4. The AP of claim 2, wherein the processing device is operable to identify, at the AP, the one or more STAs on the NPCA primary channel based on one or more frames sent from the one or more STAs in response to the initial control frame.

5. The AP of claim 4, wherein the one or more frames are sent in assigned resource units.

6. The AP of claim 1, wherein the one or more STAs comprises a plurality of STAs that has mixed operational bandwidth.

7. The AP of claim 1, wherein the processing device is operable to switch, at the AP, from the NPCA primary channel to the primary channel when transmission on the NPCA primary channel is completed.

8. A station (STA), comprising:
a processing device operable to:
receive, at the STA from an access point (AP), an initial control frame on a non-primary channel access (NPCA) primary channel;
send, from the STA to the AP, one or more frames on the NPCA primary channel; and
receive, at the STA from the AP, one or more downlink frames on the NPCA primary channel.

9. The STA of claim 8, wherein the processing device is operable to switch, at the STA, to the NPCA primary channel.

10. The STA of claim 8, wherein the initial control frame is a multi-user buffer status report polling (MU BSRP) trigger frame.

11. The STA of claim 8, wherein the one or more frames are sent in assigned resource units.

12. The STA of claim 8, wherein the processing device is operable to switch, at the STA, from the NPCA primary channel to the primary channel when transmission on the NPCA primary channel is completed.

13. A method, comprising:
switching, at an access point (AP), from a primary channel to a non-primary channel access (NPCA) primary channel;
identifying, at the AP, one or more stations (STAs) on the NPCA primary channel; and
sending, from the AP to the one or more STAs on the NPCA primary channel, one or more downlink frames using the NPCA primary channel.

14. The method of claim 13, further comprising:
sending, from the AP to the one or more STAs, an initial control frame.

15. The method of claim 14, wherein the initial control frame is a multi-user buffer status report polling (MU BSRP) trigger frame.

16. The method of claim 14, further comprising:
identifying, at the AP, the one or more STAs on the NPCA primary channel based on one or more frames sent from the one or more STAs in response to the initial control frame.

17. The method of claim 13, wherein the one or more frames are sent in assigned resource units.

18. The method of claim 17, wherein sending the one or more frames in assigned resource units enables the AP to identify the one or more STAs on the NPCA primary channel.

19. The method of claim 13, wherein the one or more STAs comprises a plurality of STAs that has mixed operational bandwidth.

20. The method of claim 13, further comprising:
switching, at the AP, from the NPCA primary channel to the primary channel when transmission on the NPCA primary channel is completed.
